(19) United States
(12) Patent Application Publication
(10) Pub. No.: US 2004/0028443 A1
(43) Pub. Date: Feb. 12, 2004

(54) Printing device

(76) Inventor: Michael Koblinger, Kolitzheim (DE)

Correspondence Address: Douglas R Hanscom, Jones Tullar & Cooper, Eads Station, PO Box 2266, Arlington, VA, 22202, US

(21) Appl. No.: 10/416,159

(22) PCT Filed: Oct. 15, 2001
(86) PCT No.: PCT/DE01/03942

(30) Foreign Application Priority Data
Nov. 17, 2000 (DE) 10057063.1

(51) Int. Cl. B41J 3/54

(52) U.S. Cl. 400/82

(57) ABSTRACT

A printing device is usable to print a material which is bent around a printing cylinder. The printing device includes a plurality of print heads and a print head holder. The print head holder positions the print heads in a common holder plane which is defined by the holder. The print heads are disposed in a row that is inclined relative to the printing device at an acute angle. The print heads are also inclined relative to the holder plane so that they are directed at substantially a right angle to the material to be printed.

The invention relates to a printing device in accordance with the preamble of claim 1.

The present invention relates to a printing device for imprinting material to be imprinted, which is curved around a printing cylinder, having a plurality of print heads and a print head holder for seating the print heads on a holding plane defined by the print head holder, wherein the print heads are arranged along the print head holder in a row which extends at an acute angle in respect to the printing direction.

“Printing direction” here means the running direction of the material to be imprinted in relation to the print heads. If the material to be imprinted travels around the printing cylinder, the printing direction extends vertically in relation to the axis of rotation of the printing cylinder.

As a rule, ink jet printers operate with two print heads, namely with one for color printing and one for black printing. A movement around two axes takes place between the material to be imprinted and the print heads. The material to be imprinted is moved in the printing direction, and the print heads are moved transversely to this, so that the image points can be exactly aligned with each other by means of a chronological control of the shot times. As a rule, printing of flat material takes place, so that positional deviations of the individual image points in respect to their neighboring image points are small, and accordingly there is also only a slight distortion of the printed image.

However, the disadvantage of these systems is their limited printing speed and the requirement for exact control of the shot time of the printing nozzles in relation to the axes of movement. The latter is complicated, because the movement of the print head in relation to the material to be imprinted is multi-axial.

For achieving a high printing speed, along with a simple control, a plurality of print heads can be arranged next to each other for covering the entire printing width. The movement between the material to be imprinted is single-axial, only a movement of the material to be imprinted in the printing direction takes place. For achieving a compact arrangement of the print heads, and accordingly a high resolution, the individual print heads can be placed obliquely in relation to the printing direction and arranged offset from each other in the printing direction, so that the print points of the print heads complement each other and cover the entire width of the material to be imprinted.

To make possible a simple mounting and arrangement of the print heads, it is desirable to always fasten at least two of the print heads on a common level print head holder. However, in this connection it is difficult to prevent distortions of the printed image and to achieve a high print quality, in particular when printing on curved material to be imprinted.

GB 2 349 607 A shows a printing device with a plurality of print heads, which are arranged offset in respect to each other. These print heads are arranged inclined in the radial direction in respect to a printing cylinder.

U.S. Pat. No. 4,864,328 shows an ink jet print head with several rows of nozzles, which are inclined in respect to the printing direction.

The object of the invention is based on providing a printing device of compact arrangement and with a high printing quality.

In accordance with the invention, this object is attained by means of the characteristics of claim 1.

The advantages which can be obtained by means of the invention lie in particular in that the printing device prints at a high speed, achieves a high print quality and prevents distortions of the printed image. The print heads are inclined in relation to the holder plane in such a way that they spray substantially vertically onto the material to be imprinted. Because of the inclined arrangement of the print heads it is possible to use a level print head holder and, at the same time the print heads can print substantially vertically on corresponding set points. Distortions of the printed image are prevented by this and it is possible to achieve an outstanding print quality in spite of the highest printing speed.

The print heads can be inclined on the print head holder relative to the holder plane as a function of their distance. In particular, the inclination is set as a function of the distance between the respective print heads from the holder center, wherein holder center means the section of the print head holder located closest to the printing cylinder and which is vertically intersected by a straight diameter line through the printing cylinder. If the print heads are arranged in pairs symmetrically in respect to the holder center, the distance of the print heads from the holder center corresponds to one-half the distance of the print heads from each other, so that the inclination can be set as a function of the distance of the print heads from each other.

In a further development of the invention, the print heads are inclined in relation to the holder lever as a function of the acute angle by which the print heads are placed obliquely, or at which the row of print heads extends in relation to the printing direction. The obliquely placed print heads of a row are fastened on a common print head holder, so that the longitudinal direction of the print head holder corresponds to the orientation of the row, and accordingly the inclination of the print heads in relation to the print head holder is set as a function of the acute angle of the print head holder in relation to the printing direction.

For achieving a simple adjustment of the print heads in relation to the print head holder, the print heads are inclined at two different angles on two planes extending vertically in respect to each other. They can be inclined in particular on the holder plane and on a plane vertically thereto. The directions of the angles to be set are predetermined, regardless of the angle of inclination actually to be set, because of which the preconditions for mounting can be simply and precisely preset and executed.

In accordance with an advantageous embodiment of the invention, the print heads can be inclined at a first angle on a plane which is defined by a straight connecting line through the print heads on the respective print head holder and the straight diameter line through the printing cylinder, which intersects this straight connecting line. Thus the first angle is located on a plane containing the longitudinal direction of the print head holder and cuts an ellipse out of the printing cylinder. In this case the first angle of each print head is selected in such a way that the spraying direction of the respective print head extends vertically on a tangent line at a set point against the ellipse which is cut out of the printing cylinder by the said plane.

In a further development of the invention, the print heads are each inclined relative to the holder plane at a second angle on a plane which extends vertically in respect to the straight connecting line through the print heads which are mounted on a print head holder, and extends through the respective print head. Thus the second angle lies on a plane vertically in respect to the holder plane.

For being able to imprint a respectively wide material to be imprinted over its entire width, without displacing the print heads transversely to the printing direction, a plurality of print head holders are arranged parallel with each other, each of which supports a plurality of obliquely place print heads. The inclination of the print heads in relation to each print head holder is set in the manner previously described.

An exemplary embodiment of the invention is represented in the drawings and will be described in greater detail in what follows.

Shown are in:

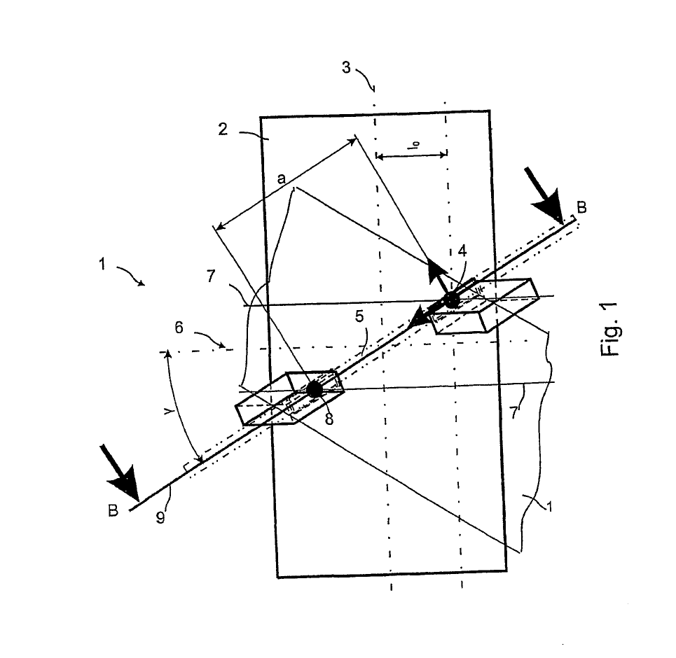

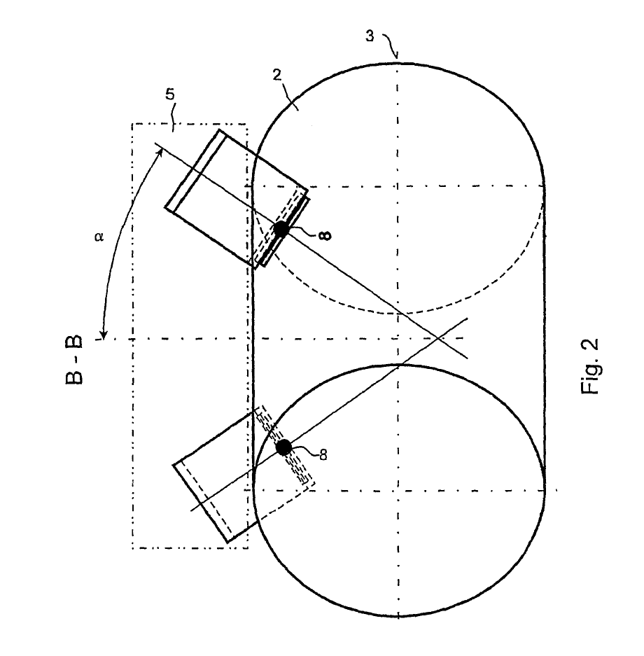

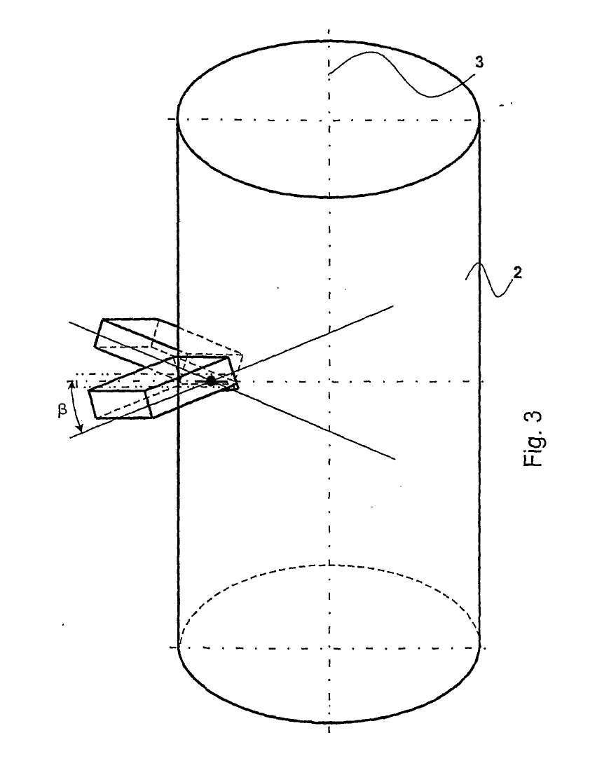

FIG. 1, a view from above on a printing device with a printing cylinder, a print head holder and two print heads seated thereon in a schematic representation, FIG. 2, a section along the line B-B in FIG. 1, FIG. 3, a lateral view of the printing device in a direction of view parallel with the longitudinal extension of the print head holder,

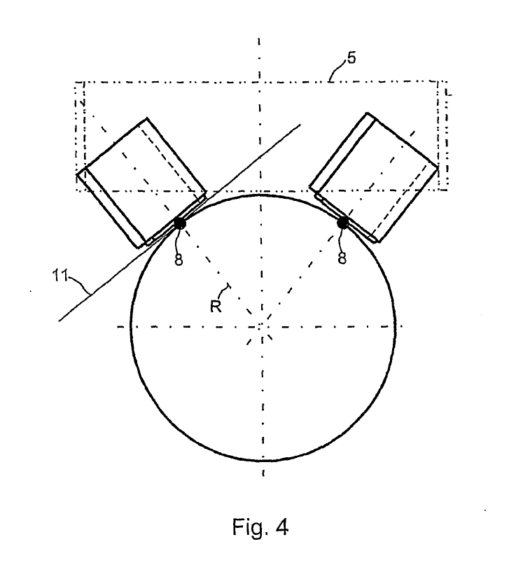

FIG. 4, a front view of the printing device in a direction of view parallel with the axis of rotation of the printing cylinder.

The printing device 1 comprises a printing cylinder 2, which is seated rotatable around its longitudinal axis 3. The material to be imprinted moves around the printing cylinder 2 and is curved corresponding to the printing cylinder 2. Paper or the like can be provided as the material to be imprinted, so that printing by means of the printing device 1 takes place directly on the material to be imprinted. The printing device 1 can also be provided for placing images on printing plates for offset printing. In this case a printing plate is mounted on the printing cylinder 2. Initially, an image is placed on the printing plate by means of the printing device 1 in order to perform printing with the latter.

The printing device 1 has a plurality of print heads 4 as the printing group, which operate in accordance with the ink jet principle and spray a stream or small droplets on the material to be imprinted. For reasons of clarity only two print heads 4 are represented in the drawings, which are fastened on a common print head holder 5. It is of course understood that a plurality of print heads 4 are provided transversely to the printing direction 6 next to each other and are fastened to print head holders 5 located next to each other, so that the print areas of the individual print heads 4 complement each other and cover the entire width of the material to be imprinted.

In the embodiment represented, two print heads 4 are arranged on the print head holder 5. The print head holder 5 is embodied to be level, it defines a holder plane B-B, in which all print heads 4 seated on it are arranged. As shown in FIG. 1, the print heads 4 are obliquely placed. They are oriented at an acute angle gamma in respect to the printing direction 6, so that they can be arranged more densely and for achieving a higher resolution of the printed image. Corresponding to the oblique placement of the print heads 4, the print head holder 5 extends in its longitudinal direction at the angle gamma in respect to the printing direction 6 in order to be able to seat both print heads 4 (see FIG. 1).

The print heads 4 are arranged symmetrically to the holder center of the print head holder 5, i.e. they are identically spaced apart from the holder center of the print head holder 5. In this case the holder center of the print head holder 5 is defined as the point which lies closest to the printing cylinder 2. This point is in turn defined in that a radius R, or a straight diameter line of the printing cylinder 2 through the holder center, extends vertically on the print head holder 5. As shown in FIG. 1, the print heads 4 are spaced apart from each other by the distance a, accordingly, the distance of each of the print heads 4 from the holder center is ½a.

The print heads 4 are inclined in relation to the print head holder 5, so that their spray axis 7 is oriented substantially vertically on the set point 8 of the printing cylinder 2 and they accordingly spray vertically onto the material to be imprinted. In this case the print heads 4 are inclined at two different angles in relation to the print head holder 5, which are located on planes which extend vertically to each other.

A first angle alpha, at which the print heads 4 are inclined relative to the print head holder 5, is located on the holder plane B-B, which is constituted for one by the longitudinal direction of the print head holder 5, or of the straight connection line 9 through the print heads 4, and furthermore by the straight diameter line passing through the holder center of the print head holder 5 and extending vertically in respect to it. The holder plane B-B is the drawing plane in which FIG. 2 lies.

The holder plane B-B cuts an ellipse 10 out of the printing cylinder 2, which can be seen in FIG. 2, since the holder plane B-B is inclined at the angle gamma, or 90°-gamma, to the longitudinal axis 3 of the printing cylinder 2. The print heads 4 are inclined relative to the print head holder 5 at the angle alpha, so that each sprays on the assigned set point 8 on the printing cylinder 2. In this case the angle alpha is of such a size that the spray axis 7 of the respective print head 4 is oriented vertically on a tangent line through the respective set point 8. In the section B-B in accordance with FIG. 2, the tangent line appears as a tangent line on the ellipse 10 through the set point 8. The print head 4 is oriented vertically on this line.

The angle of inclination alpha in the holder plane B-B in relation to the print head holder 5 is determined here in the following manner:

alpha=arctan(cos(gamma)·tan(psi), wherein

psi=arcsin(xᵢ·cos(gamma))/R, wherein

xᵢ=R·sin(phi)/cos(gamma), wherein

phy=lₒ·(360/2R pi), wherein

lₒ=a/2·cos(gamma), with

a=the distance of the print heads from each other, and

R=radius of the print cylinder 2.

The angle of inclination gamma of the print heads 4 in respect to the printing direction 6 is 31°, for example, The radius of the printing cylinder 2 is 181 mm, for example, and the distance of the print heads 4 on the print head holder 5 is for example 52.66 mm. In this case the print head 4 is inclined at an angle alpha of 6.03°.

In addition to the inclination at the angle alpha, each print head 4 is inclined at a second angle beta relative to the print head holder 6 in order to prevent as much as possible the distortion of the printed image in spite of the curvature of the printed image. The angle beta lies on a plane which extends vertically in respect to the holder plane B-B. The plane on which the angle beta lies, extending vertically to the holder plane B-B, extends in particular vertically to the longitudinal direction of the print holder head 5, or the straight connecting line 9 through the print heads 4. The reference point of beta is located in the plane, the print head is located outside the plane, i.e. the angle beta represented is distorted by the angle alpha. The plane of the angle beta is the plane in FIG. 3.

The angle beta is determined in that the spray axis 7 of the respective print head 4 is oriented substantially vertically on the tangent plane 11 at the print cylinder 2 through the respective set point 8. The angle of inclination beta of the print head 4 is in particular determined in the following manner:

beta=arcsin(sin(phi)·sin(gamma)), wherein

phi=lₒ·(360/2R pi), wherein

lₒ=a/2·cos(gamma), with

a=distance of the print heads from each other, and

R=radius of the printing cylinder 2.

With the values for gamma, R and a given above, the angle beta is 3.61°.

Inclination setting devices are arranged between the print heads 4 and the print head holder 5 for setting the said two inclination angles alpha, beta, which can be integrated into the seating of the print heads 4 on the print head holder 5. The inclination setting devices, not further shown in the drawings, are preferably embodied in two axes, i.e. they can only be moved, or set, on the two planes in which the angles alpha and beta are located. In principle, ball-headed bearings or the like would be conceivable, however, an inclination setting device with separate setting axes has the advantage that the two inclination angles alpha, beta can be set independently of each other, so that the mounting, or adjustment, is correspondingly simplified.

With the described printing device 1 only the material to be imprinted is moved during the printing process. The print heads 4 need not be moved transversely to the printing direction 6. It is nevertheless possible by means of the described printing device 1 to achieve an outstanding and distortion-free printed image at the highest printing speed.

This printing device applies a means for changing the coating (it is possible to apply an additional coating, properties of the coating can be changed) of a printing forme, in particular a planographic printing forme of a printing press.

List of Reference Symbols

| | |
|---|---|
| 1 | Printing device |
| 2 | Printing cylinder |
| 3 | Longitudinal axis |
| 4 | Print head |
| 5 | Print head holder |
| 6 | Printing direction |
| 7 | Acute angle |
| 8 | Set point |
| 9 | Straight connecting line |
| 10 | Ellipse |
| 11 | Tangent plane |
| a | Distance |
| R | Radius |
| B-B | Holder plane, section |
| alpha | Angle, inclination angle (B-B) |
| gamma | Angle, oblique positioning angle |
| beta | Angle, inclination angle (4) |

1. A printing device for imprinting materials to be imprinted, which are curved around a printing cylinder (2), having a plurality of print heads (4), a print head holder (5) for seating the print heads (4) on a holder plane (B-B) defined by the print head holder (5), characterized in that nozzle openings of the print heads (4) are arranged along a row which is inclined at an acute angle (gamma) in respect to the printing direction (6), that the holder plane (B-B) is inclined at an acute angle (gamma) in respect to the printing direction (6), and that a direction, which extends radially in respect to the axis of rotation (3) of the printing cylinder (2) and is arranged vertically to the printing direction (6), is located on the holder plane (B-B), that the print heads (4) are arranged inclined in respect to the holder plane (B-B) in such a way that they are oriented substantially vertically on the material to be imprinted.

2. The printing device in accordance with claim 1, characterized in that the print heads (4) are inclined on the print head holder (5) as a function of their distance (a).

3. The printing device in accordance with one of the preceding claims, characterized in that the print heads (4) are inclined as a function of the acute angle (gamma).

4. The printing device in accordance with one of the preceding claims, characterized in that the print heads (4) are inclined at two angles (alpha, beta) in two planes extending vertically in respect to each other.

5. The printing device in accordance with one of the preceding claims, characterized in that the print heads (4) are inclined at an angle (alpha) in respect to a radial direction of the printing cylinder (2) on the holder plane (B-B).

6. The printing device in accordance with the preceding claim, characterized in that the print heads (4) are inclined in such a way that the angle (alpha) meets the following relationship:
tan(alpha)=(cos(gamma)·tan(psi), wherein
psi=arcsin(xᵢ·cos(gamma))/R, wherein
xᵢ=R·sin(phi)/cos(gamma), wherein
phy=lₒ·(360/2R pi), wherein
lₒ=a/2·cos(gamma), with
a=distance of the print heads (4) from each other, and
R=radius of the print cylinder.

7. The printing device in accordance with claim 1, characterized in that each of the print heads (4) is inclined at an angle (beta) in respect to the holder plane (B-B).

8. The printing device in accordance with the preceding claim, characterized in that the print heads (4) are inclined in such a way that the angle (beta) meets the following relationship:
beta=arcsin(sin(phi)·sin(gamma)), wherein
phi=lₒ·(360/2R pi), wherein
lₒ=a/2·cos(gamma), with
a=distance of the print heads (4) from each other, and
R=radius of the printing cylinder.

9. The printing device in accordance with one of the preceding claims, characterized in that a plurality of print head holders (5) is arranged parallel with each other and each supports a plurality of print heads (4).

10. The printing device in accordance with claim 1, characterized in that the printing device applies a means for changing the coating or a coating to a printing forme.

11. The printing device in accordance with claim 10, characterized in that the printing forme is embodied as a planographic printing plate.
